(19) United States
(12) Patent Application Publication
(10) Pub. No.: US 2005/0224679 A1
(43) Pub. Date: Oct. 13, 2005

(54) Mouse pad

(76) Inventors: Ingmar Sohn, Berlin (DE); Sven Heisig, Berlin (DE)

Correspondence Address: BIRCH STEWART KOLASCH & BIRCH, PO BOX 747, FALLS CHURCH, VA, 22040-0747, US

(21) Appl. No.: 10/995,326

(22) Filed: Nov. 24, 2004

(30) Foreign Application Priority Data
Nov. 25, 2003 (DE) 20318374.6

(51) Int. Cl. G09G 5/08; B32B 9/00

(52) U.S. Cl. 248/346.01; 248/918; 428/40.1; 428/172

(57) ABSTRACT

A mouse pad (10) for use as a substrate to move computer mice across, comprising a flexurally rigid backing (11) having a roughed coating (12) thereon, wherein that coating (12) consists of polytetrafluoroethylene.

The present invention relates to a mouse pad for use as a substrate for computer mice to move across and comprising a flexurally rigid backing which has a roughed coating applied thereto.

Mouse pads of this type are used frequently as sliding supports and for the protection of manual computer control devices, so-called mice. Computer mice perform their control function by means of a rolling element, i.e. a ball, or in a quasi-non-contacting manner by optoelectronic scanning. On the one hand, such pads should have some hardness and surface roughness so that mice comprising a rolling element experience a sufficient frictional resistance; on the other hand, if operating in a non-contacting manner and scanning by optoelectronic means, they are supposed to detect and precisely signal any movement of the mouse. In addition, they are supposed to be hand- and grip-friendly.

DE 299 15 203 U1 discloses a mouse pad consisting of hypoallergenic plant-tanned leather. DE 298 22 273 U1 discloses a mouse pad stated to consist of glass, metal, ceramic, wood or a composite material. These materials do in fact have a fairly hard surface, but are too smooth to offer much frictional resistance.

Finally, DE 298 00 298 U1 discloses a mouse pad consisting of a biologically reproductive and biodegradable material. These prior mouse pads have a very smooth surface which prevent a precise control action from being obtained or they are so soft that control malfunction is frequent.

It is the object of the present invention to provide a mouse pad of the kind initially described which enables a precise control to be obtained even where the velocity of mouse movement is very high and the computer mouse comprises no rolling element.

This object is achieved by the coating comprising polytetrafluoroethylene. Specifically, the coating may be polytetrafluoroethylene and preferably sintered-on polytetrafluoroethylene. Another embodiment comprises a mouse pad for use as a substrate for computer mice to move across which comprises a one-piece backing having flexural rigidity which consists of polytetrafluoroethylene and has a roughed surface.

These measures result in a mouse pad which make it possible to control computers by means of rolling element-type mice as well as by non-contacting optoelectronic scanning in the microsecond range. As the inventor has found, polytetrafluoroethylene enables a precise computer control performance to be obtained especially where optoelectronic scanning is used.

Further advantageous measures are described in the dependent claims. The invention is illustrated in the attached drawings and is described hereinbelow.

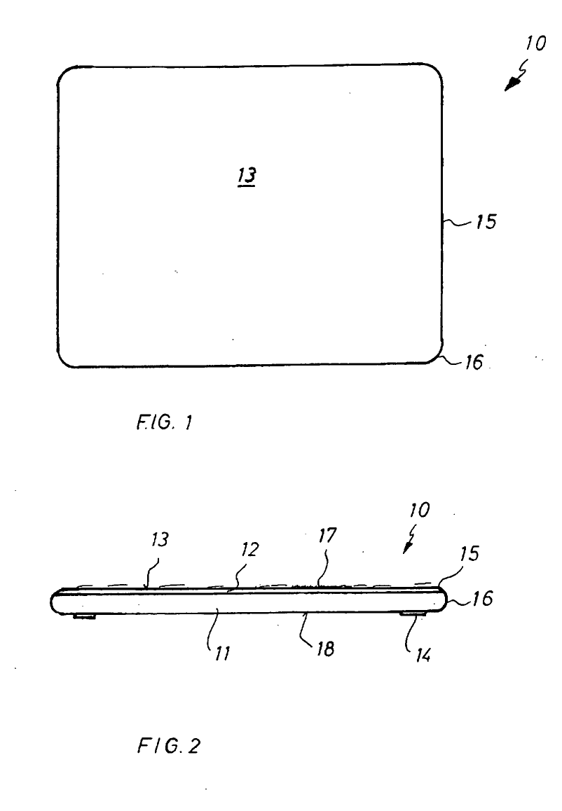

FIG. 1 is a schematic top plan view of a mouse pad;

FIG. 2 shows a side view of the mouse pad in FIG. 1.

Referring now to FIG. 1, there is schematically shown a mouse pad 10 which essentially comprises a flexurally rigid backing 11 having a coating 12 applied thereto, as shown in FIG. 2. Coating 12 has a surface 13 provided with roughing 17. In order to avoid injury, the edges 15 of mouse pad 10 may be rounded, as shown at 16.

Sintering at approx. 200° C. to 260° C. may be used to obtain a natural irregular roughing 17 the depth of which may be 0.1 to 0.5 times the thickness of coating 12. Coating 12 has a thickness of 0.1 to 0.5 mm.

Backing 11 consists of a flexurally rigid material such as a light-weight metal, sheet steel or a plastics material. On its bottom surface 18 opposite coating 12, backing 11 may be provided with anti-skid nubs 14.

Anti-skid nubs 14 consist of an elastomer and may be adhesively bonded in place, for example. They are supposed to prevent the skidding of mouse pad 10 in response to rapid movements of a computer mouse (not shown).

In computer games players often need to react with utmost rapidity. Their hand movements should be transferred to the computer without noticeable delay. Usually, such movements are detected using mice operating by laser or by optoelectronic scanning. For enhanced scanning, polytetrafluoroethylene coating 12 may be tinted a dark color.

In one embodiment, mouse pad 10 may consist integrally of a single polytetrafluoroethylene material. In particular, it may consist of a tinted polytetrafluoroethylene roughened as at 17 on its surface 13.

### List of References

10 mouse pad
11 backing
12 coating
13 surface
14 anti-skid nubs
15 edge
16 rounding
17 roughing
18 bottom surface

1. A mouse pad for use as a substrate to move computer mice across, comprising a flexibly rigid backing having a roughed coating thereon, wherein the coating (12) includes polytetrafluoroethylene.

2. The mouse pad as in claim 1, wherein the coating (12) consists of a layer of polytetrafluoroethylene powder sintered onto the backing.

3. The mouse pad as in claim 1, wherein a roughing (17) of the coating (12) is irregular.

4. The mouse pad as in claim 1, wherein the backing (11) includes sheet metal.

5. The mouse pad as in claim 1, wherein the backing (11) includes a light-weight metal.

6. The mouse pad as in claim 1, wherein the backing (11) includes a thermally stable plastics material.

7. The mouse pad as in claim 1, wherein the backing (11) has a thickness approximately ten to twenty times the thickness of coating (12).

8. The mouse pad as in claim 1, wherein the coating (12) has a thickness of 0.1 to 0.5 mm.

9. The mouse pad as in claim 1, wherein the polytetrafluoroethylene (12) is tinted a dark color.

10. A mouse pad as a substrate for computer mice to move across, comprising a one-piece backing (11) having flexible rigidity, formed of polytetrafluoroethylene, and has having a surface (13) provided with a roughing (17).
